(19) United States
(12) Patent Application Publication
(10) Pub. No.: US 2019/0112233 A1
(43) Pub. Date: Apr. 18, 2019

(54) METHOD FOR PRODUCING A MOLDED PART FROM GLASS FIBER AND/OR MINERAL FIBER MATERIAL, MOLDED PART WHICH CAN BE OBTAINED USING SAID METHOD, AND MANUFACTURING UNIT FOR THIS PURPOSE

(71) Applicant: DBW HOLDING GMBH, Bovenden (DE)

(72) Inventor: Thomas Franz Josef BAUER, Bovenden (DE)

(21) Appl. No.: 16/099,845

(22) PCT Filed: May 11, 2017
(86) PCT No.: PCT/EP2017/061335

§ 371 Date: Dec. 4, 2018

(30) Foreign Application Priority Data
May 12, 2016 (DE) 10 2016 108 800.5

(51) Int. Cl. C04B 28/26; C04B 14/42; C04B 28/24; C04B 40/00; F01N 13/14; F01N 13/16; F01N 13/18

(52) U.S. Cl. CPC C04B 28/26; C04B 14/42; C04B 28/24; C04B 40/001; C04B 2111/52; F01N 13/14; F01N 13/16; F01N 13/1861; C04B 40/0014

(57) ABSTRACT

The invention relates to a method for producing a molded part from glass fiber and/or mineral fiber material with an inorganic binder. The inorganic binder is cured using electromagnetic radiation in order to form the molded part. The tool is designed to be at least partly permeable for the electromagnetic radiation for curing purposes, and the inorganic binder is a binder which can be cured by electromagnetic radiation. The invention further relates to a molded part which can be obtained in the aforementioned manner. Finally, the invention relates to a manufacturing unit for producing a molded part from glass fiber and/or mineral fiber material and an inorganic binder. The manufacturing unit comprises a device for providing a tool for forming the molded part, a device for introducing the glass fiber and/or mineral fiber material and the inorganic binder into the tool, a device for generating electromagnetic radiation to cure the inorganic binder in order to form a molded part, and optionally a device for removing the molded part from the tool.

The present invention relates to a process for producing a molding from glass fiber material and/or mineral fiber material with an inorganic binder. The inorganic binder is cured here by means of electromagnetic radiation to form the molding; the mold is designed such that it is at least partly transparent to the electromagnetic radiation for curing and the inorganic binder is one curable by electromagnetic radiation. The present invention further relates to a molding thus obtainable. Finally provided is a manufacturing unit for the production of a molding from glass fiber material and/or mineral fiber material and an inorganic binder. This manufacturing unit comprises a device for providing a mold to form the molding, a device for introducing the glass fiber material and/or mineral fiber material and the inorganic binder into the mold, a device for generating electromagnetic radiation to cure the organic binder to form the molding, and optionally a device for removing the shaped molding from the mold.

### STATE OF THE ART

The use of inorganic binders for production of moldings is known. For instance, DE 10 2005 001 796 A1 describes a molding for fire protection in which an inorganic reinforcement weave serves as carrier material for the building material. The carrier material used may be a glass fiber mesh weave. The organic binder used is a sodium silicate and/or potassium silicate. In addition, tubular moldings which are wound with the mesh weave of the desired diameter and impregnated with the binder used accordingly in order to form corresponding moldings.

DE 195 32 291 describes mufflers composed of an outer shell and an inner shell comprising heat-resistant fibers. Binder coatings are used to fix the fibers. Suitable binders include those based on silicon dioxide and aluminum oxide as the main constituent. These binders are applied and dewatered in a drying operation.

DE 31 44 193 A1 describes a sound-absorbing body especially suitable for incorporation in a muffler. The binder is, for example, one bonded by means of waterglass adhesive in order to bond the moldings to one another.

DE 10 2007 032 431 A1 discloses a construction for heat insulation, wherein two layers are bonded using an organic adhesive and/or high-temperature adhesive, for example a waterglass-based adhesive.

DE 20 2014 100 285 U1 discloses a thermal insulator molding for an offgas system of an internal combustion engine in which an inorganic binder, especially a sheet silicate, is used. This insulation molding is hot-pressed.

In the production of shaped bodies or moldings for acoustic insulation or thermal insulation, for example in mufflers, nowadays essentially organic binders are used. For example, thermoplastics are used in the form of fixing filaments or as binders. WO 2010/122076 describes various types of binders or fixing agents for glass fiber products, wherein not only reactive adhesives, hotmelt adhesives, inorganic adhesives or waterglass but also thermoplastics in particular are listed as suitable forms.

The moldings and shaped bodies used nowadays particularly in the acoustic and insulating region of mufflers consist of textured mineral endless fibers wound in multiple plies and organic binders distributed homogeneously therein. The shaped body is consolidated here by a thermal treatment, in that the organic binders are cured.

One disadvantage of the sound-absorbing moldings and shaped bodies known from the prior art is that they either have to be processed in a complex manner in order to obtain the desired shape or that they receive their shape and integrity for better installation through the addition of organic binders. However, the organic binders have a low melting point/boiling point and burn at high temperatures, and so they are no longer effective as a binder. Furthermore, the combustion of the organic binders additionally gives rise to emissions that pollute the environment.

Indeed, it has been found that the organic binders break down at temperatures of even 180° C. This is especially also true of the size present on the fibers and rovings.

There is therefore a need to provide processes that provide moldings made from glass fibers or mineral fibers with binders having improved mechanical properties. Drying of the organic or inorganic binders applied in liquid form has been accomplished to date by drying at temperatures exceeding 300° C., typically at about 400° C.

### DESCRIPTION OF THE INVENTION

This object is achieved by a process for producing a molding from glass fiber material and/or mineral fiber material with an inorganic binder, comprising the steps of:
providing a mold to shape the glass fiber material and/or mineral fiber material to form the molding;
introducing the glass fiber material and/or mineral fiber material and the inorganic binder into the mold;
curing the inorganic binder by means of electromagnetic radiation within a range from 1×10⁴ Hz to 4×10¹⁴ Hz, such as 1×10⁶ Hz to 1×10¹² Hz, to form the molding;
removing the cured molding from the mold,
   where the mold is designed in such a way that it is transparent to the electromagnetic radiation for curing and the inorganic binder is curable with the electromagnetic radiation.

It has been found that curing of the inorganic binder by means of electromagnetic radiation overcomes the disadvantages as arise through hot pressing, for example at temperatures of 250° C. or higher, as used to date. For instance, there is no breakdown of the size. Furthermore, the moldings obtained have improved mechanical properties. For instance, there was an improvement in tensile strength and compressive strength. More particularly, there was a significant improvement in tear strength and breaking strength. The moldings obtained have mechanical and acoustic properties similar to or better than those of moldings produced with organic binders. However, it is possible to work at low temperatures, such that neither the fiber material nor the mold is significantly heated. The radiation evaporates the solvent, such that curing of the binder occurs. The materials, i.e. the fibers and the binder in particular, but even the sizes as well, are not combusted or carbonized. This creates very homogeneous structures with high masses at low energy expenditure.

Furthermore, the process of the invention allows a short processing time, and the unwanted emissions are distinctly reduced.

More particularly, the process allows the use of molds to form the molding, where these molds are not subject to any significant heating, but it is instead possible to use plastics, for example, as molds.

It has been found in the present context that the process of the invention allows low-temperature curing, typically at below 120° C., such as below 110° C., and hence a lower energy input compared to conventional processes is needed. For instance, it has been found that the molds are not heated to temperatures above 100° C., for example to temperatures below 100° C., such as below 95° C., for example below 90° C. This value relates more particularly to the temperature on the outside of the mold.

In one embodiment, in accordance with the invention, the glass fiber material and/or mineral fiber material is textured glass fiber material and/or mineral fiber material, such as effect-textured glass fiber material and/or material fiber material. When effect-textured fibers are used, the amount used per unit volume can be reduced without alteration of the acoustic properties. This can be explained by a uniform distribution in the molding. The reduction in the amount per unit volume here may be at least 10%, such as 15% or more or 20% or more, based on the amount per unit volume.

The molds are designed such that they are at least partly, such as completely, transparent to the electromagnetic radiation in the range from 1×10⁴ Hz to 4×10¹⁴ Hz, such as 1×10⁶ Hz to 1×10¹² Hz, for example in the radio-frequency range or microwave range, for curing of the inorganic binder. The molds are transparent to the radiation at least to such an extent that curing of the inorganic binder is possible. Suitable ranges include, as one limit, 1×10⁵ Hz, such as 1×10⁶ Hz, for example 2×10⁶ Hz. The other limit of the range may be 1×10¹⁴ Hz, such as 1×10¹³ Hz, for example 1×10¹² Hz, such as 1×10¹¹ Hz. It was found that, through use of this electromagnetic radiation for curing, with appropriately designed molds, moldings made of glass fiber material and/or mineral fiber material are obtainable, especially those made from textured glass fiber material and/or mineral fiber material, such as effect-textured glass fiber material and/or mineral fiber material, which can be provided with lower energy input and reduced emission of pollutants.

The curing in the mold can already be effected here in such a way that a further element, such as a hot gas-guiding component in the case of a muffler to be manufactured, is at least partly enveloped by the molding material introduced and the inorganic binder.

The expression “glass fiber material and/or mineral fiber material”, also referred to hereinafter as fiber material, is understood in the present context to mean corresponding fibers, for example in the form of continuous fibers, which are in the form of continuous filaments, especially in the form of rovings. “Continuous” is understood here to mean a length of ≥250 mm.

The expression “textured” means that the glass fiber material and/or mineral fiber material, in the form of a roving, yarn or twine for example, is opened up by means of known methods. Textured fibers are known in the prior art and have the feature that the opening of the fibers achieves an increase in volume. The fibers thus textured, owing to their fullness, have improved thermal and acoustic properties. In one embodiment, the glass fiber material and/or mineral fiber material comprises effect-textured glass fiber materials or mineral fiber materials. The expression “effect-textured” is understood in the present context to mean that a second filament or roving (main filament) is wound around a core filament or base filament or roving. Both the wound filament and the base filament may have been correspondingly textured, i.e. are in opened-up form.

The expression “glass fiber material and/or mineral fiber material”, also referred to hereinafter as fiber material, is understood to mean both material composed of glass fibers and material composed of glass fibers and other mineral fibers, such as basalt fibers or mineral wool, unless stated otherwise, and mixtures thereof.

In one embodiment, according to the invention, the glass fiber material is an E glass, S glass or ECR glass or combinations thereof.

These glasses may take the form of continuous glass fiber rovings in textured or effect-textured form; examples of suitable materials include the Powertex and Powertex LE fibers from DBW Advanced Fiber Technologies GmbH.

The mold used in the process of the invention is designed such that it is transparent to the electromagnetic radiation for curing of the molding. Furthermore, the mold is designed, for example, such that excess solvent, typically water, can escape, for example such that the water vapor can escape from the mold through suitable openings. The mold may correspondingly be equipped with a sufficient number of openings to discharge these media.

Suitable materials at least to form the subregion of the mold which is transparent to the electromagnetic radiation are plastics materials such as polypropylene (PP), polyethylene (PP), polytetrafluoroethylene (PTFE), polyvinyl chloride (PVC) and mixtures of these, but also materials such as glass or ceramic. A material of good suitability is polypropylene. It has been found that this heats up only slightly, for example to a maximum of 100° C., such as a maximum of 95° C., such as a maximum of 90° C. This is particularly true of the temperature on the outside of the mold.

The molds may be in one-part or multipart form and may additionally be designed such that they have gaps for further elements, such as pipes or dividers. This makes it possible to at least partly enclose hot gas-guiding elements or components of mufflers with the mold in the course of curing of the glass fiber material and/or mineral fiber material with the inorganic binder.

The molds may be designed such that they can be filled from the outside with the glass fiber material and/or mineral fiber material and the inorganic binder. Such a filling operation can be effected manually or in a semiautomatic or fully automatic manner. The molds themselves may likewise be provided, opened and/or closed manually, semiautomatically or fully automatically.

The fiber material, namely the glass fiber material and/or mineral fiber material, can be introduced into the mold by means of a nozzle, for example. The introduction can be effected in such a way that the fiber material is introduced simultaneously with the inorganic binder in the injection operation. Alternatively, the fiber material and the inorganic binder can be injected separately. In a further embodiment, the fiber material can be pretreated with the inorganic binder and is then introduced, for example injected, into the mold in correspondingly coated form with the inorganic binder. In the course of injection, the texturing can also be effected, such as the effect-texturing of the fibers.

In one embodiment, the inorganic binder is a sodium-, potassium- and/or lithium-based waterglass. Silica sol can be used alternatively or in combination. Silica sol is a water-dissolved SiO₂. The binder may be in liquid to pasty form. Alternatively, it may also be introduced in powder form. The proportion of the binder may be up to 15% by weight in solid form—based on the molding with fiber and binder in solid form. In one embodiment, the binder is present in an amount of up to 10% by weight, such as up to 5% by weight, of solids. The binder itself may be, and may be used, in solution or in the form of a dispersion or suspension. It may include further inorganic admixtures. Suitable solvents are especially aqueous solvents, such as pure water, which may be in the form of a dispersion, suspension or emulsion.

An essential aspect of the process of the invention is the curing with electromagnetic radiation which is within a range from 1×10⁴ Hz to 4×10¹⁴ Hz, such as 1×10⁶ Hz to 1×10¹² Hz. In one embodiment, the radiation is radiofrequency radiation or microwave radiation, for example as achieved with conventional radiation units. For instance, instruments with microwaves in the region of 2.45 GHz or radiofrequency ranges of 27.12 MHz are obtainable.

The process of the invention can be conducted in a manufacturing unit in a semiautomatic and/or fully automatic manner. The mold may take the form of a single-use mold. Such single-use molds include plastic-based bags, but also other shaping molds.

The process of the invention is especially one wherein the molding to be produced consists of the glass fiber material and/or mineral fiber material and the inorganic binder.

The inorganic binder is, for example, known silicate binders based on sodium silicate, potassium silicate, lithium silicate or mixed silicates thereof. Alternatively or in combination, it is possible to use silica sol; it is also possible to use solid pulverulent silicates such as a sodium silicate etc. The person skilled in the art is aware of suitable inorganic binders for use with glass fiber materials and/or mineral fiber materials.

In one embodiment, the inorganic binder is one having a pH greater than 9, for example greater than 9.5, such as ≥10.

In a further aspect, moldings thus obtainable are provided. These moldings made from glass fiber material and/or mineral fiber material with inorganic binder are especially suitable as moldings for acoustic and/or insulating purposes, for example as muffler inserts or other insulating and/or acoustic components used in motor vehicle construction. These moldings are made, for example, from textured glass fiber materials and/or mineral fiber materials, such as effect-textured glass fiber materials and/or mineral fiber materials.

These moldings of the invention feature low emission on heating and, because the size remains on the fibers, show improved mechanical properties. These moldings differ from known moldings produced by hot pressing or by warming, especially by heating, such as heating by means of the mold during the production process, in that, for example, the size remains on the fiber surface. The moldings have improved mechanical properties, such as tensile strengths and compressive strengths or tear strengths or breaking strengths.

In a further aspect, the present application is directed to a manufacturing unit for a molding made from glass fiber material and/or mineral fiber material and an inorganic binder, comprising a device for provision of a mold for formation of the molding, where said mold is transparent to electromagnetic radiation within a range from 1×10⁴ Hz to 4×10¹⁴ Hz, such as from 1×10⁶ Hz to 1×10¹² Hz; a device for introducing the glass fiber material and/or mineral fiber material and the inorganic binder into the mold; device for generating electromagnetic radiation within the abovementioned range for curing of the inorganic binder to form the molding; device for removing the shaped molding from the mold.

This manufacturing unit comprises a device for providing a mold to form the molding. This device introduces the mold into the manufacturing unit and optionally guides it to the further devices of the unit. The person skilled in the art is aware of suitable devices for providing and conveying the mold.

This device provides the molds in such a way that the molds are guided by their region at least partly transparent to electromagnetic radiation to the device for generating the electromagnetic radiation in such a way that the materials present in the mold are correspondingly irradiated in this device.

The manufacturing unit further comprises a device for introducing the glass fiber material and/or mineral fiber material and the inorganic binder into the mold.

As already set out above, such a device may comprise an injection with a nozzle of appropriate design. This device may be designed such that it applies the inorganic binder to the glass fiber material and/or mineral fiber material prior to introduction into the mold and then introduces these correspondingly into the mold. Alternatively, this device may be designed such that introduction of the binder and of the glass fiber material and/or mineral fiber material are effected separately or successively. The person skilled in the art is aware of suitable devices. These devices may optionally further include supply devices for supplying the glass fiber material and/or mineral fiber material, and reservoirs for the inorganic binder and/or the fiber material etc. The manufacturing unit and here the device for introducing the fiber material may have an upstream device for (effect) texturing of the glass fiber material and/or mineral fiber material. The texturing, such as the effect texturing, of the fiber material can also be effected in the introduction operation, for example a nozzle in particular.

The manufacturing unit of the invention further comprises a device for generating electromagnetic radiation for curing of the inorganic binder in the mold to form the cured molding. This device comprises means of generating the desired electromagnetic radiation within a range from 1×10⁴ Hz to 4×10¹⁴ Hz, such as 1×10⁶ Hz to 1×10¹² Hz, for example a unit for generating infrared radiation, a microwave or a unit for generating a radiofrequency. This device is designed such that the electromagnetic radiation is directed at the mold and here to the region of the mold transparent to the electromagnetic radiation, such that it can penetrate into the mold and permits curing of the molding therein. The person skilled in the art is aware of suitable devices; for instance, this device may be a tunnel or an oven through which the molds are transported on a conveying unit.

This device may also contain elements that draws off the solvent released in the course of curing, such as the water vapor.

The manufacturing device optionally further comprises a device for removing the shaped molding from the mold. For this purpose, the mold together with the finished molding, after leaving the device for producing electromagnetic radiation for curing, for example via conveying means, is conveyed onward to the device for removing the shaped molding from the mold. This removal of the shaped molding can be accomplished in a semiautomatic or automatic manner by opening the mold. The mold may be a repeatedly usable mold or a singly usable mold. Such a mold includes a bag or other structures for single use. A corresponding removal of the shaped molding, in the case of single-use articles, may include the destruction of the mold.

In one embodiment, the device for introduction of the fiber material, for example a nozzle, is designed such that it simultaneously includes wetting of the optionally textured, especially the optionally effect-textured, glass fiber material and/or mineral fiber material with the inorganic binder.

In one embodiment, the manufacturing unit has a control unit which semiautomatically or fully automatically controls the manufacturing unit.

In a further embodiment, the manufacturing unit is one wherein the molding is manufactured in one uninterrupted working step.

In a further embodiment, the mold from which the finished molding has been removed is returned to the device for introducing the glass fiber material and/or mineral fiber material and the inorganic binder into the mold, meaning that the device for guiding the mold may have a continuous conveying device.

In one embodiment, the molding produced in accordance with the invention is a muffler insert.

In a further aspect, the present invention is directed to a process for producing mufflers, comprising the step of introducing a molding obtainable by the process of the invention or a molding of the invention into a muffler or part of a muffler.

In one execution, the curing of the molding takes place after at least partial enclosure of a hot gas-conducting component.

The person skilled in the art is aware of suitable processes for producing the muffler. For instance, the molding of the invention can be introduced or inserted into a first outer shell or a second outer shell or pulled over a hot gas-conducting component, such that this hot gas-conducting component is at least partly enclosed by the molding of the invention. Introduction of the molding of the invention is followed by closure of the muffler.

What is claimed in a further aspect is a muffler produced by a process of the invention.

The molding of the invention obtainable by a process of the invention is one for use as an acoustic and/or insulating component, especially in a muffler.

The moldings of the invention may also take on more complex shapes, especially three-dimensionally shaped moldings. These formed moldings may also be intrinsically stable, such that they are easily insertable within a system and optionally exchangeable.

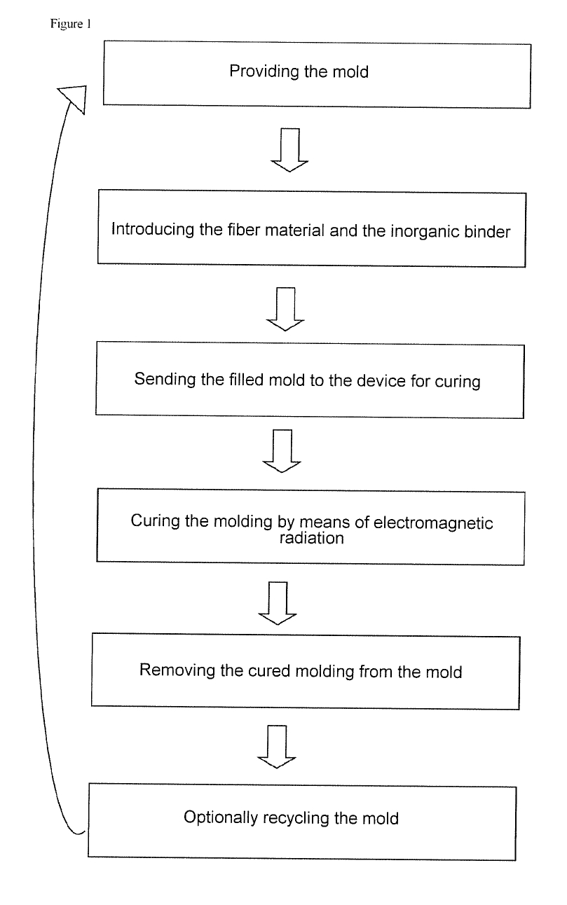

With reference to FIG. 1, the process of the invention is elucidated once again. FIG. 1 is a flow diagram of the process of the invention.

In the first step, the molding is provided, in order then, in the second step, to introduce the glass fiber material and/or mineral fiber material and the inorganic binder into the mold. As stated, the fiber may have been wetted with the binder beforehand; alternatively, the glass fiber material and/or mineral fiber material may be introduced into the mold simultaneously with the inorganic binder or successively. In the further step, the mold with the uncured glass fiber material and/or mineral fiber material introduced together with the binder is then brought to the device for curing the molding. This device has a source of electromagnetic radiation for curing of the binder.

In the subsequent step, the glass fiber material and/or mineral fiber material is cured to give the molding by means of electromagnetic radiation in the device for producing electromagnetic radiation for curing the inorganic binder to form the molding. After the curing, the mold together with the cured molding is passed onward in order to remove the cured molding from the mold. If appropriate, the reusable mold is provided again for filling.

1. A process for producing a molding from glass fiber material and/or mineral fiber material with an inorganic binder, comprising the steps of:
providing a mold to shape the glass fiber material and/or mineral fiber material to form the molding;
introducing the glass fiber material and/or mineral fiber material and an inorganic binder into the mold;
curing the inorganic binder by subjecting it to electromagnetic radiation within a range from 1×10⁴ Hz to 4×10¹⁴ Hz to form a cured molding;
removing the cured molding from the mold,
wherein the mold is transparent at least in subregions to the electromagnetic radiation for curing, and wherein the inorganic binder is curable with the electromagnetic radiation.

2. The process as claimed in claim 1, wherein the glass fiber material and/or mineral fiber material is a textured glass fiber material and/or mineral fiber material.

3. The process as claimed in claim 1 wherein the glass fiber material is an E glass, S glass or ECR glass or combinations of these.

4. The process as claimed in claim 1 wherein the mold that is transparent to the electromagnetic radiation is or includes a material selected from the group consisting of polypropylene (PP), polyethylene (PE), polytetrafluoroethylene (PTFE), polyvinylchloride (PVC), glass, ceramic or mixtures of these.

5. The process as claimed in claim 1 wherein the inorganic binder is or includes a sodium-, potassium- and/or lithium-based waterglass, and/or a silica sol.

6. The process as claimed in claim 1 wherein the proportion of the inorganic binder in the molding is not more than 15% by weight of solids based on the molding.

7. The process as claimed in claim 1 wherein the electromagnetic radiation is radiofrequency radiation or microwave radiation.

8. The process as claimed in claim 1 wherein one or more of the steps are effected in a semiautomatic or fully automatic manner in a manufacturing unit.

9. The process as claimed claim 1 wherein the glass fiber material and/or mineral fiber material is introduced into the mold by means of a nozzle, where i) the glass fiber material and/or mineral fiber material has optionally been pretreated with inorganic binders or ii) the glass fiber material and/or mineral fiber material is injected together with the inorganic binder.

10. The process as claimed in claim 1 wherein the inorganic binder has a pH of >9.

11. The process as claimed in claim 1 wherein each of the steps are performed so as to produce a molding consisting of glass fiber and/or mineral fibers and inorganic binder.

12. The process as claimed claim 1 wherein a temperature of the mold in the curing step does not exceed 100° C.

13. The process as claimed claim 1 wherein the mold takes the form of a single-use mold.

14. A molding obtained by a process according to claim 1.

15. A manufacturing unit for a molding made from glass fiber material and/or mineral fiber material and an inorganic binder, comprising:
a device for provisioning of a mold for formation of the molding, where said mold is transparent at least in subregions to electromagnetic radiation within a range from 1×10⁴ Hz to 4×10¹⁴ Hz;
a device for introducing the glass fiber material and/or mineral fiber material and the inorganic binder into the mold;
a device for generating electromagnetic radiation for curing of the inorganic binder to form the molding;
a device for removing a shaped molding from the mold.

16. The manufacturing unit as claimed in claim 15, wherein the device for generating electromagnetic radiation generates microwaves and/or radiowaves.

17. The manufacturing unit for a molding as claimed in claim 15 wherein the device for introducing glass fiber material and/or mineral fiber material is a nozzle, optionally designed for texturing of this glass fiber material and/or mineral fiber material and/or for feeding in the inorganic binder.

18. The manufacturing unit as claimed in claim 17, wherein the device for introducing glass fiber material and/or mineral fiber material is designed to simultaneously wet textured, glass fiber material and/or mineral fiber material with the inorganic binder.

19. The manufacturing unit as claimed in claim 15 further comprising a control unit for controlling one or more of operations of the manufacturing unit in a semiautomatic or fully automatic manner.

20. The manufacturing unit as claimed in claim 15 wherein the manufacturing unit is configures such that the molding is produced in one uninterrupted operating step.

21. A process for producing mufflers, comprising the step of introducing a molding obtained by the process set forth in claim 1 into a muffler or part of a muffler.

22. The process as claimed in claim 21, wherein the curing of the molding as claimed in claim follows at least partial enclosure of a hot gas-guided component.

23. A muffler produced by a process as claimed in claim 21.

24. A method for affecting sound or heat of a machine or device comprising the step of using a molding produced according to claim 1 as an acoustic and/or insulating component.
